(19) United States
(12) Patent Application Publication
(10) Pub. No.: US 2005/0194442 A1
(43) Pub. Date: Sep. 8, 2005

(54) Label applicator with RFID antenna

(76) Inventors: Matthew Thomas Adams, Mason, OH (US); Kevin Conwell, Fairfield, OH (US)

Correspondence Address: ORUM & ROTH, 53 W. JACKSON BLVD, CHICAGO, IL, 60604, US

(21) Appl. No.: 10/944,332

(22) Filed: Sep. 17, 2004

Related U.S. Application Data
(60) Provisional application No. 60/504,780, filed on Sep. 18, 2003.

(51) Int. Cl. G06K 7/00

(52) U.S. Cl. 235/439; 340/572.7; 340/572.8

(57) ABSTRACT

A label applicator with a patch antenna or in the label applicator. The antenna is able to read and/or write to an RFID tag embedded in the label as the label is being applied to an object. The antenna can write the most current information to the RFID tag as the label is being applied. The antenna also can read the RFID tag and identify failed or damaged tags so they can be disguarded.

This application claims the benefit of U.S. provisional application 60/504,780 entitled Label Applicator with RFID Antenna copy filed Sep. 18, 2003.

### BACKGROUND OF THE INVENTION

1. Field of the Invention

The present invention relates to smart labels. More specifically it relates to a label applicator with an integrated RFID antenna for reading and/or writing to a smart label containing an RFID transponder.

2. Description of Related Art

RFID labels provide a good reliable labeling solution where a line of site to a bar code label is unavailable. RFID smart labels also provide fast, reliable, accurate data collection without human error or replication.

No smart label applicator exists today in the Automatic Identification Industry that is designed to read/write to smart labels during label application.

There is a need for a labeling system that can read/write to smart labels as they are applied to an article.

There is a need for a system which reduces the complexity of the process and the cycle time. Writing to tag during application of smart label can reduce cycle time on the conveyor line (one step rather than two).

There is a need for a system that allows for writing to an RFID tag where a separate antenna is not feasible due to space limitations, RF interference or other environmental interference.

### SUMMARY OF THE INVENTION

Radio frequency transponders (also known as “RFID tags”) generally include an antenna and integrated memory circuit with read/write capability used to store digital information, such as an electrically erasable programmable read only memory (EEPROM) or similar electronic device. Active RFID tags include their own radio transceiver and power source (battery) and are generally sealed within a molded plastic housing or “button”. Passive RFID tags are energized to transmit and receive data by an electromagnetic field and do not include a radio transceiver or power source. As a result they are small and inexpensive with limited range, resolution, and data storage capacity.

Passive RFID tag “inserts” used in the Automatic Identification Industry are typically laminated or inserted into a paper or plastic label stock backed with pressure sensitive adhesive for applying the printed label to a carton, pallet, airline baggage, parcel, or the other article to be tracked. These labels are commonly referred to as “smart labels”.

This applicator design incorporates a patch antenna into the label applicator head for reading/writing to the embedded RFID insert as the smart label is applied to an article. The antenna can be mounted, attached or built into the applicator platen head, or it can be mounted anywhere on the applicator unit in proximity to the smart label. For example, the antenna could be in the frame of the unit so when the label passes the antenna it reads/writes. The applicator can be designed to read the embedded RFID insert and discard the bad smart label prior to applying it on an article. It is important that the writing of the smart label occur just before applicator so that the most current data can be written to the RFID tag. If the RFID tag is written to before it reaches the applicator head, there might be a problem on the manufacturing line (product gets out of queuing order) that would result in the wrong information being written to the smart label before application. This invention can apply to automated label applicators or print and apply devices, as well as manual (hand held) label applicators or print and apply devices. The label applicator can be for pressure sensitive labels (self adhesive), wet activated labels, heat seal activated labels, or sonic weld methods of attachment.

The inventive applicator head allows RFID smart label attachment and writing/programming in one single step. Integration of a patch antenna into an existing label applicator can save time and labor to read/write to the smart label at a later station. With the antenna in the label applicator head the RF tag can be written to in the same step as it is applied to an article.

Integrating the antenna in the label applicator eliminates the need for an additional write antenna station.

This invention can also provide a means to write to the RFID tag in situations where using an antenna array is not feasible due to space limitations or RF/environmental interference.

### BRIEF DESCRIPTION OF THE DRAWINGS

FIG. 1 is a label applicator.

### DETAILED DESCRIPTION OF THE INVENTION

Radio frequency transponders (also known as “RFID tags”) generally include an antenna and integrated memory circuit with read/write capability used to store digital information, such as an electrically erasable programmable read only memory (EEPROM) or similar electronic device. Active RFID tags include their own radio transceiver and power source (battery) and are generally sealed within a molded plastic housing or “button”. Passive RFID tags are energized to transmit and receive data by an electromagnetic field and do not include a radio transceiver or power source. As a result they are small and inexpensive with limited range, resolution, and data storage capacity.

Passive RFID tag “inserts” used in the Automatic Identification Industry are typically laminated or inserted into a paper or plastic label stock backed with pressure sensitive adhesive for applying the printed label to a carton, pallet, airline baggage, parcel, or the other article to be tracked. These labels are commonly referred to as “smart labels”.

The inventive applicator incorporates a patch antenna into the label applicator head for reading/writing to the embedded RFID insert as the smart label is applied to an article. The antenna can be mounted, attached or built into the applicator platen head, or it can be mounted anywhere on the applicator unit in proximity to the smart label. In one embodiment, the antenna is in the frame of the unit so when the label passes the antenna it reads/writes. The applicator may also designed to read the embedded RFID insert and discard the bad smart label prior to applying it on an article. It is important that the writing of the smart label occur just before or just after application so that the most current data can be written to the RFID tag. If the RFID tag is written to before it reaches the applicator head, there might be a problem on the manufacturing line (product gets out of queuing order) that would result in the wrong information being written to the smart label before application. The RFID antenna can be used with automated label applicators or print and apply devices, as well as manual (hand held) label applicators or print and apply devices. It may be used with the label applicators for pressure sensitive labels (self adhesive), wet activated labels, heat seal activated labels, or sonic weld methods of attachment.

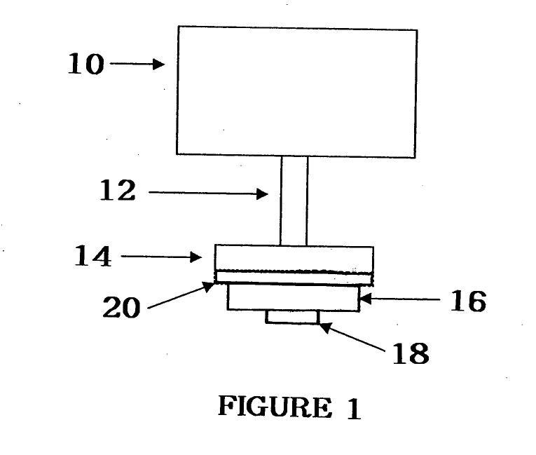

Referring to FIG. 1, a first preferred embodiment is shown. The applicator unit 10 has an arm 12 with an applicator head 14 on a far side. The antenna 20 is located on the applicator head 14. The applicator head 14 picks up a label 16 containing an RFID 18 for attachment to an object (not shown).

An alternative embodiment could include the antenna 18 within the rubber portion of the applicator head 14. In doing so the proper read/write distance can be obtained.

The inventive applicator head allows RFID smart label attachment and writing/programming in one single step. Integration of a patch antenna into an existing label applicator can save time and labor to read/write to the smart label at a later station. With the antenna in the label applicator head the RF tag can be written to in the same step as it is applied to an article.

Integrating the antenna in the label applicator eliminates the need for an additional write antenna station.

This invention can also provide a means to write to the RFID tag in situations where using an antenna array is not feasible due to space limitations or RF/environmental interference.

1. A label applicator comprising:
an applicator having an applicator unit, an applicator head attached to said unit, and an antenna on said applicator.

2. The label applicator of claim 1 wherein the antenna is mounted on the applicator unit.

3. The label applicator of claim 2 wherein the antenna is in a frame of the applicator unit.

4. The label applicator of claim 1 wherein the antenna is mounted on the applicator head.

5. The label applicator of claim 1 wherein the antenna is attached to the applicator head.

6. The label applicator of claim 1 wherein the antenna is built into the applicator head.

7. The label applicator of claim 1 wherein the antenna is mounted within a rubber portion of the applicator head.

8. The label applicator of claim 1 wherein the label applicator unit is selected from the group consisting of pressure sensitive label applicators, self adhesive label applicators, wet activated label applicators, heat seal activated label applicators, sonic weld application applicators and combination label applicators.

9. A method for applying a smart label and writing/reading the smart label in a single step; the method comprising the following steps:
utilizing an applicator unit having an antenna for reading and/or writing an RFID label,
passing the label by the antenna as the label passes the applicator head,
reading and/or writing to the RFID tag, and
applying the label to an object.

10. The method of claim 9 further comprising the step of writing to the RFID.

11. The method of claim 10 further comprising the step of reading the RFID.

12. The method of claim 11 further comprising the step of discarding the label if the RFID is damaged.
